(19) United States
(12) Patent Application Publication
(10) Pub. No.: US 2013/0000407 A1
(43) Pub. Date: Jan. 3, 2013

(54) Inspection System And Methods For Integral Seals

(75) Inventors: Dong Fei, Peoria, IL (US); Douglas Rebinsky, Peoria, IL (US); Colm Flannery, Chillicothe, IL (US)

(73) Assignee: CATERPILLAR, INC, Peoria, IL (US)

(21) Appl. No.: 13/171,937

(22) Filed: Jun. 29, 2011

(51) Int. Cl. G01N 29/04

(52) U.S. Cl. 73/588

(57) ABSTRACT

An inspection system for integral seals includes an ultrasonic transducer configured to ultrasonically scan an integral seal having a rubber sealing member attached to a seal carrier, and a transducer positioning mechanism defining a plurality of translational degrees of freedom and a rotational degree of freedom. An electronic control unit is coupled with the ultrasonic transducer, and may be configured to store data indicative of a defect in the integral seal responsive to a reflection pattern defined by ultrasound reflected by the rubber sealing member and the seal carrier. Related methodology is also disclosed.

### TECHNICAL FIELD

The present disclosure relates generally to non-destructively inspecting an integral seal, and relates more particularly to detecting a defect in an integral seal responsive to an ultrasound reflection pattern.

### BACKGROUND

A great many types of seals are used in mechanical systems to retain fluid within or exclude fluid from certain areas. Rubber sealing members are commonly used to fluidly seal between adjacent metallic parts and the like. Transmissions, crankcases, fuel systems, and cooling systems are common examples of mechanical systems in vehicles where liquids such as oil, water, fuel, or coolant are sealed within and among machine components. Pumps, compressors, conveyors, and all manner of other familiar systems utilize rubber seals. Such seals are also used in more exotic environments, such as spacecraft, to contain or exclude gases, for instance. For a variety of reasons, among them providing mechanical support to a rubber sealing member, a second component generally referred to as a seal carrier may be attached to a rubber sealing member to enable or enhance its performance.

Those skilled in the art will be familiar with consequences of seal failure. In the case of a failed seal in certain types of machine systems, such as vehicle air conditioning, the consequences can be an annoyance but not necessarily critical. In the case of seal failure in other systems such as a transmission or fuel system, the consequences can range from mild to catastrophic. While the causes of seal failure can often be deduced from inspecting failed seals, engineers have struggled for many years with the problem of how to detect or predict potential problems with a seal prior to placing it in service. U.S. Pat. No. 7,194,914 to Fei et al. is directed to an apparatus and method for scanning internal structure of O-rings. In particular, Fei et al. describe a technique for scanning internal flaws such as undesired internal surfaces and/or cracks in an O-ring using ultrasound.

### SUMMARY OF THE DISCLOSURE

In one aspect, an inspection system for detecting a defect in an integral seal having a rubber sealing member attached to a seal carrier includes an ultrasonic transducer configured to ultrasonically scan an integral seal positioned for inspection via a fixture. The system further includes a transducer positioning mechanism defining a plurality of translational degrees of freedom and a rotational degree of freedom, and being configured to move the ultrasonic transducer relative to the integral seal such that the ultrasonic transducer tracks a contour defined by the rubber sealing member. The system further includes a control system coupled with the ultrasonic transducer and with the transducer positioning mechanism and having a computer readable memory and an electronic control unit. The electronic control unit is configured to store data on the computer readable memory indicative of a reflection pattern defined by ultrasound reflected by the rubber sealing member and ultrasound reflected by the seal carrier during tracking the contour of the rubber sealing member with the ultrasonic transducer.

In another aspect, a method of inspecting an integral seal having a rubber sealing member attached to a seal carrier includes transmitting ultrasound from an ultrasonic transducer toward the integral seal, and receiving ultrasound reflected by the rubber sealing member, and ultrasound reflected by the seal carrier. The method further includes detecting a defect in the integral seal responsive to a reflection pattern defined by the received ultrasound.

In still another aspect, a method of detecting a defect in an integral seal includes transmitting ultrasound from an ultrasonic transducer toward an integral seal having a rubber sealing member and a seal carrier attached to the rubber sealing member, and receiving ultrasound reflected by the rubber sealing member, and ultrasound reflected by the seal carrier, the received ultrasound defining a reflection pattern. The method further includes outputting a signal responsive to detecting a defect in the integral seal indicated by the reflection pattern.

### BRIEF DESCRIPTION OF THE DRAWINGS

FIG. 1 is a diagrammatic view of an inspection system according to one embodiment;

FIG. 2 is a side diagrammatic view of a portion of the system of FIG. 1, and including an example signal trace illustration;

FIG. 3 is another side diagrammatic view, similar to FIG. 2, and including another example signal trace illustration;

FIG. 4 is another side diagrammatic view, similar to FIG. 2, and including another example signal trace illustration; and

FIG. 5 is a graphic of an ultrasonic scan, according to one embodiment.

### DETAILED DESCRIPTION

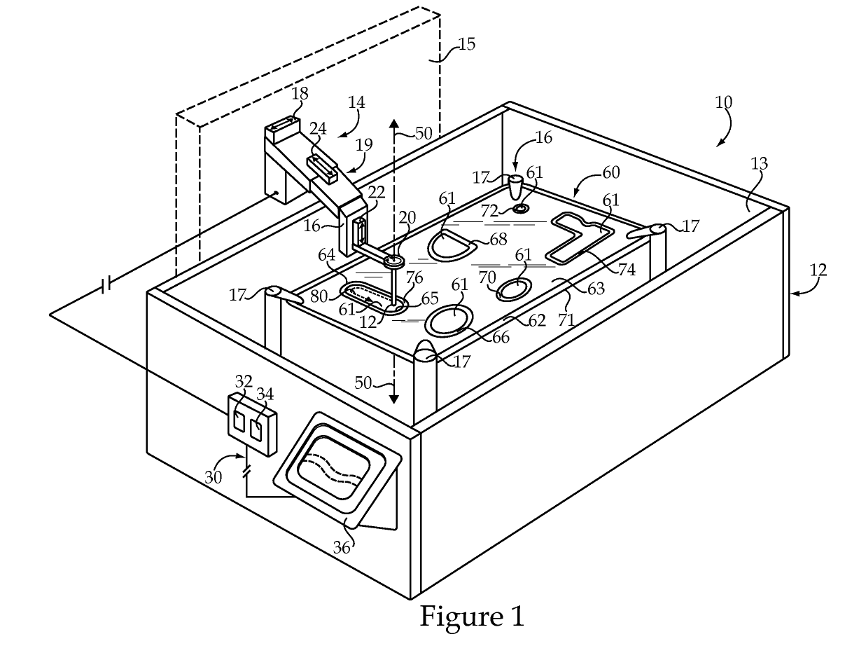

Referring to FIG. 1, there is shown an inspection system 10 according to one embodiment. Inspection system 10 may include a housing 12 having an immersion tank configured to contain a liquid such as water, and a fixture 16 having a plurality of holders 17 and being configured to position an integral seal 60 for inspection in a manner further described herein. Inspection system 10 may be configured for detecting a variety of types of defects in an integral seal to enable evaluation of the suitability of the integral seal for service in a machine system. As will be further apparent from the following description, inspection system 10 may autonomously, or by way of assisting a human operator, enable the non-destructive detection of certain types of defects previously discovered only upon failure of an integral seal, or by cutting the seal apart and thus rendering it unsuited for service.

System 10 may include an ultrasonic transducer 12 configured to ultrasonically scan an integral seal such as seal 60. As alluded to above, ultrasonic scanning of an integral seal according to the present disclosure may include ultrasonic immersion scanning, which will be familiar to those skilled in the art. A transducer positioning mechanism 14 may be coupled with ultrasonic transducer 12 and may be configured to move ultrasonic transducer 12 relative to integral seal 60 in a manner and for purposes further described herein. In the illustrated embodiment, integral seal 60 includes a seal carrier 62 having an upper surface 63, a lower surface 71, and a plurality of apertures 61 communicating between upper surface 63 and lower surface 71. A plurality of rubber sealing members 64, 66, 68, 70, 72 and 74 are associated one with each of apertures 61 to provide fluid seals between adjacent components of a machine system. Rubber sealing members discussed herein may be formed from synthetic or natural polymers such as polyisoprene, from other rubber-like elastomeric polymers, or blends, for instance.

Those skilled in the art will readily appreciate that each of the subject fluid seals may be disposed between fluidly communicating passages or cavities in the adjacent machine components. The purpose of seal carrier 62 may be to provide structural support and appropriate shaping for each of the fluid seals, as well as positioning the fluid seals at predefined locations to facilitate assembly of the associated machine system. In one embodiment, integral seal 60 may be a seal of a type used in a vehicle transmission system, however, the present disclosure is not thereby limited. Similarly, while a total of six apertures 61 each equipped with a rubber sealing member are shown, integral seal 60 might include a greater number or lesser number of apertures, for forming a greater or lesser number of fluid seals. In one embodiment, an integral seal inspected in the manner contemplated herein might include a single aperture and single rubber sealing member. It may further be noted that each of apertures 61 includes a unique shape, a shape shared by the respective rubber sealing members. Other integral seals might include apertures having identical shapes. Further still, while each of apertures 61 has a closed shape, in other instances the apertures might include an open shape having an open side at an edge of an associated seal carrier. As used herein, the term “integral seal” should be understood to refer to a sealing mechanism having a seal carrier and at least one rubber sealing member attached to the seal carrier. The one or more rubber sealing members may be attached to an inner or outer edge of the seal carrier, whether that edge defines a closed shape or an open shape, but might instead be attached to a face of the seal carrier. The attachment may be by way of an adhesive, by way of the rubber material of the rubber sealing member adhering to the seal carrier during curing, or a mechanical locking connection, for example, based on the respective shapes of the rubber sealing member and seal carrier. Seal carrier 62 may be formed from a metallic material such as a flat sheet of metal having apertures 61 formed therein by stamping, punching or cutting, for instance. The present disclosure is not strictly limited to use with integral seals having a metallic seal carrier, however and it may thus be understood that a component having a seal carrier formed from a material other than metal might also be inspected via system 10 and related methodology disclosed herein. One example includes a rubber sealing member attached to a polycarbonate seal carrier.

In FIG. 1, rubber sealing member 64 is shown positioned as it might appear for ultrasonic scanning via ultrasonic transducer 12. An inboard edge 65 of rubber sealing member 64 faces the corresponding aperture 61. An outboard edge 65 adjoins seal carrier 62. In other instances, an integral seal scanned via system 10 might include an inboard edge of a rubber sealing member adjoining a seal carrier, and an exposed outboard edge forming all or part of an outer periphery of the integral seal. In view of the foregoing discussion, it will be readily apparent that a vast number of different types of integral seals may be inspected according to the present disclosure.

As mentioned above, transducer positioning mechanism 14 may be configured to move ultrasonic transducer 12 relative to integral seal 62. Mechanism 14 may move transducer 12 such that transducer 12 tracks a contour defined by one of the rubber sealing members. In FIG. 1, rubber sealing member 64 includes a generally oval shape having straight sides and rounded ends, similar to a shape of common track and field running or automobile driving tracks. Accordingly, the contour defined by rubber sealing member 64, and in particular a contour defined by inboard edge 65, may include a generally oval contour in a plane defined by upper surface 63 of seal carrier 62. Rubber sealing members 66 and 72 may be understood to define generally circular contours, whereas rubber sealing member 70 may define an oval contour having rounded sides and more sharply rounded ends than the contour defined by rubber sealing member 64. Rubber sealing member 68 may be understood to define a D-shaped contour, whereas rubber sealing member 74 may be understood to define a complex contour. In the case of each of these contours, as well as others contemplated therein, positioning mechanism 14 may be used to move transducer 12 relative to integral seal 60 such that transducer 12 defines a travel path parallel to the inboard edge of a rubber sealing member of interest. An ultrasonic transmitter of transducer 12 may be maintained normal to and facing the rubber sealing member during tracking its contour, as further described herein. The description herein of transducer 12 tracking a contour defined by a rubber sealing member may thus be understood to mean that transducer 12 moves in a travel path which itself defines a shape similar to the contour defined by the rubber sealing member of interest. In certain embodiments, transducer 12 may be moved such that its travel path defines a shape congruent with the rubber sealing member of interest, however, the present disclosure is not strictly limited as such.

Rubber sealing members used in integral seals often have a uniform thickness and uniform cross-sectional shape. For such seals, it will typically be desirable to maintain transducer 12 during tracking at a uniform distance from an edge of the subject rubber sealing member and at a uniform orientation relative thereto. In other instances, however, a rubber sealing member might include a varying thickness or otherwise varying shape, and in such cases transducer 12 might be moved such that its distance from the rubber sealing member or orientation changes. In still other instances, certain types of defects might be expected to be more likely to occur at certain points along an interface between a rubber sealing member and a seal carrier and for this reason it might be desirable to position transducer 12 relatively closer or relatively further from the rubber sealing member at such locations or at certain orientations to optimize scanning for a particular type of defect. During ultrasonically scanning an integral seal, a focal point of ultrasound transmitted from transducer 12 may be maintained approximately along a longitudinal geometric center axis of the rubber sealing member of interest. This factor too could be varied, however, either by changing the manner in which ultrasound is focused or by changing the distance from the rubber sealing member of interest. In FIG. 1, transducer 12 may be moved along a travel path 80 to ultrasonically scan integral seal 60 for defects in rubber sealing member 64, defects in seal carrier 62 in the vicinity of rubber sealing member 64, or both. It may be noted that travel path 80 is generally congruent with a contour defined by inboard edge 65 of rubber sealing member 64.

In order to move transducer 12 in the manner described herein, transducer positioning mechanism 14 may define a plurality of translational degrees of freedom and a rotational degree of freedom. To this end, mechanism 14 may include a plurality of actuators. A first actuator 20 may include a rotational actuator coupled with transducer 12 and configured to rotate transducer 12 about a vertical axis 50. A robotic arm or the like, referred to herein in a non-limiting sense as a linkage 19, may couple transducer 12 with a support base 15. Support base 15 may include a part of or be coupled with housing 12, but might be a stand alone device in other embodiments. A plurality of additional actuators may be coupled with linkage 19 to move transducer 12 in linear directions, as opposed to the first and second rotational directions enabled by actuator 20. In particular, a second actuator 22 may move transducer 12 in ascending and descending vertical directions along axis 50. Another actuator 24 may move transducer 12 in a first horizontal direction relative to axis 50. Yet another actuator 18 may move transducer 12 in yet another horizontal direction relative to axis 50. In view of the foregoing, it will be understood that each of actuators 18, 22 and 24 may be configured to move transducer 12 in linear directions, whereas actuator 20 may be configured to move transducer 12 in rotational directions. In a three dimensional coordinate system, actuator 22 might be understood to move transducer 12 up or down along a y-axis, actuator 24 might be understood to move transducer 12 along an x-axis, and actuator 18 might be understood to move transducer 12 along a z-axis. As such, in the embodiment shown in FIG. 1 mechanism 14 defines a total of three translational degrees of freedom and one rotational degree of freedom. Embodiments are also contemplated in which mechanism 14 includes another actuator or is otherwise configured to move transducer 12 according to a fifth degree of freedom. A rotational actuator might be used to rotate linkage 19 relative to support base 15 for this purpose. Each of actuators 18, 20, 22 and 24 may be electrical actuators such as motors of any suitable kind, and may be computer number controlled or operated via any other suitable strategy. It may be noted that mechanism 14 is disclosed as being configured to move transducer 12 relative to an integral seal, and accordingly a system which moves the integral seal while maintaining an ultrasonic transducer stationary would still fall within the scope of the present disclosure. A practical implementation system includes at least three co-acting actuators in mechanism 14. The term co-acting means that the actuators are operated simultaneously or capable of operating simultaneously. This strategy allows transducer 12 to be positioned at any location within a coordinate plane, and at any rotational orientation within the coordinate plane, at least where one of the at least three co-acting actuators includes a rotary actuator.

System 10 may further include a control system 30 coupled with transducer 12 and with mechanism 14. Control system 30 may be configured to control mechanism 14 to move transducer 12 during ultrasonically scanning a portion of an integral seal of interest positioned for inspection via a fixture such as fixture 16. Control system 30 may include a computer readable memory 32 and an electronic control unit 34 such as one or more data processors. In one embodiment, memory 32 may store a tracking algorithm configured upon execution via electronic control unit 34 to move transducer 12 along a plurality of different travel paths to sequentially ultrasonically scan a plurality of different regions of an integral seal. The stored tracking algorithm might be specific to the type of integral seal to be scanned. Accordingly, transducer 12 might be manipulated to scan integral seal 60 in a vicinity of rubber sealing member 64, then sealing member 66, then sealing member 70, 68, and so on. During scanning each of the different regions of integral seal 60, transducer 12 may be moved according to a different travel path corresponding to the different shapes and sizes to be scanned.

Electronic control unit 34 may further be configured to store data on memory 32 indicative of a reflection pattern defined by ultrasound reflected by a rubber sealing member and ultrasound reflected by a seal carrier during tracking a contour of the rubber sealing member with ultrasonic transducer 12. The data may include data indicative of an amplitude of ultrasound reflected by each of a rubber sealing member and a seal carrier, as well time of arrival of ultrasound reflections. In one embodiment, the stored data may also include image data, encoding information other than amplitude and time, such as color or other graphical information to be displayed. Where electronic control unit 34 performs the actual detection of a defect, pattern or color recognition routines might be executed via unit 34 to deduce the presence of a defect responsive to the image data. Accordingly, as transducer 12 traverses travel path 80, it may transmit ultrasound and receive reflected ultrasound. Electronic control unit 34 may store data received from transducer 12 and defining a reflection pattern associated with rubber sealing member 64 as well as seal carrier 62 where it adjoins rubber sealing member 64. Control system 30 may further include a display 36 configured to display an image, such as a B-scan image, of a rubber sealing member currently being scanned or previously scanned such that a human operator can monitor and evaluate the results of scanning

In one embodiment, electronic control unit 34 is configured to detect a defect in an integral seal such as integral seal 60 based at least in part on the reflection pattern defined by the received ultrasound. When a defect is indicated by the reflection pattern, electronic control unit 34 may responsively output a signal. The signal could include or cause an operator perceptible alert such as generating an image on display 36, changing an image color, a sound, or some other operator perceptible alert. The signal output in response to detecting a defect could also simply include an electronic signal encoding data indicating that a defect has been detected, where the defect located, and/or also potentially the type of defect which has been detected, as further described herein. In one embodiment, electronic control unit 34 may be configured to detect a defect responsive to at least one of, a number of reflections in the reflection pattern, an amplitude of reflections in the reflection pattern, and a signal phasing in the reflection pattern, in a manner also further described herein.

### INDUSTRIAL APPLICABILITY

As discussed above, system 10 may be configured to ultrasonically scan an integral seal and detect defects either by way of recognizing the defects autonomously with electronic control unit 34, or by presenting data resulting from the ultrasonic scan to a human operator trained to recognize defects. Accordingly, the presently described procedures for detecting a defect contemplate defect detection purely autonomously or defect detection involving recognition of defects by a human operator. In the case of autonomous detection, a human operator might be employed to “train” a computer to recognize defects. For instance, the operator might inspect a plurality of integral seals with a computer of the inspection system operating in a learning mode, each time identifying suitable and unsuitable images, and the numbers of defects in each. The computer could record data inputted by the operator and gradually learn to recognize tell-tale patterns, such that suspicious measurements could be flagged. A neural network algorithm might be implemented for this purpose. In any case, detecting a defect in an integral seal may include detecting the defect based at least in part on a difference between the reflection pattern described herein and an expected pattern. A number of reflections, an amplitude of reflections or a phasing of a signal derived from sensing ultrasonic reflections, or still another parameter such as a timing of reflections, may be compared with corresponding parameters in a reflection pattern known to be associated with an integral seal free of defects.

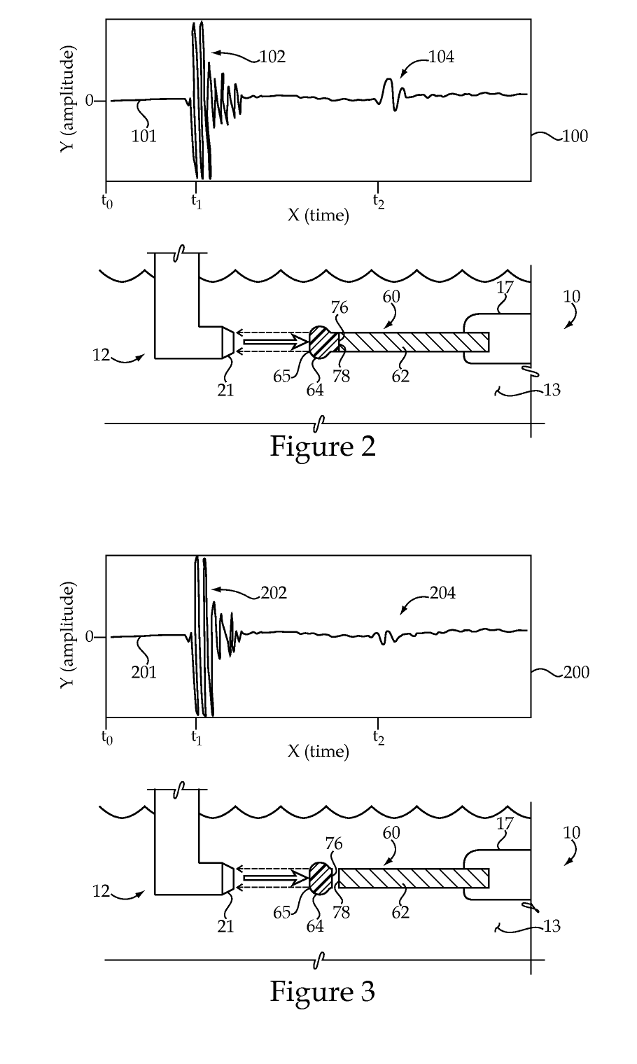

Referring now to FIG. 2, there is shown a side diagrammatic view of a portion of system 10 as it might appear during ultrasonically scanning part of integral seal 60 which includes rubber sealing member 64. Transducer 12 is shown transmitting ultrasound toward integral seal 60 from an inboard side of rubber sealing member 64. Transducer 12 may be equipped with a sensor 21, which can also serve as a transmitter such that an electrical signal sent to transducer 10 can be converted into ultrasound and transmitted towards integral seal 60, and reflected ultrasound can be sensed and converted into another electrical signal, subsequently processed or considered via electronic control unit 34 or a human operator. In either case, the electrical signal may be understood to encode data from transducer 12 which is indicative of the reflection pattern described herein, and is recorded, even if only briefly, on memory 32. FIG. 2 also shows a signal trace illustration 100 of amplitude of received ultrasound over time. The signal trace illustrated in FIG. 2 may be understood as an A-scan generated in response to the electrical signal received from transducer 12. Signal trace illustration 100 includes a signal 101 having a first signal feature 102 indicative of a first ultrasound reflection which is received beginning approximately at a time t₁, and a second signal feature 104 indicative of a second ultrasound reflection which is received beginning approximately at a time t₂. In FIG. 2, signal feature 102 represents a reflection which might be expected from inboard edge 65 of rubber sealing member 64. Signal feature 104 represents a reflection which might be expected from ultrasound reflecting from outboard edge 76 and from an edge 76 of seal carrier 62 which abuts outboard edge 78 of rubber sealing member 64. The portion of integral seal 60 shown as being scanned in FIG. 2 may be understood to be free of defects. Accordingly, signal trace 101 may be understood generally to represent a reflection pattern which is the same as an expected pattern for a defect free integral seal. As mentioned above, electronic control unit 34 might compare signal 101 or features thereof with a stored expected pattern, or a human operator might be trained to observe that signal trace 101 indicates no defects. As further discussed below, rather than an A-scan as represented in FIG. 2, a human operator might be viewing a B-scan or even a C-scan on display 36.

Turning now to FIG. 3, there is shown a portion of system 10 as it might appear when scanning a different part of integral seal 60, but still a part which includes rubber sealing member 64. Accordingly, from the state depicted in FIG. 2, transducer 12 has been advanced along travel path 80 to scan another part of integral seal 60. It may be noted that transducer 12 has approximately the same orientation and spacing from integral seal 60 in FIG. 3 as it does in FIG. 2. Maintaining a spacing and orientation may take place such that an ultrasound transmission path from transducer 12 to integral seal 60 is maintained normal to a plane of contact between rubber sealing member 64 and seal carrier 60. Accordingly, in the illustrated embodiment, ultrasound emanating from transducer 12 is generally normal to edge 78 at each of the locations depicted in FIG. 2 and FIG. 3. It will further be understood that advancing transducer 12 along its travel path may include both translating transducer 12 in one or more dimensions and rotating transducer 12 relative to integral seal 60. Translation and rotation may take place at the same time, but could occur stepwise in certain embodiments. In one practical implementation strategy, transducer 12 may transmit and sense ultrasound at a plurality of different locations or scan steps along its travel path, as opposed to continuously scanning Further, multiple scans might be performed, for instance, moving transducer 12 through its travel path more than once, and scanning at a different height each time. For seals having a rubber sealing member with a height/thickness greater than a focal diameter of the transmitted ultrasound, such an approach may provide a practical implementation strategy for ensuring all or most of the volume of the subject rubber sealing member and its interface with the seal carrier is scanned. A center frequency of transmitted ultrasound may be about 10 megahertz in one embodiment, and will typically be between about 2 megahertz and about 20 megahertz. Focal length of transducer 12 might be set at about 13 mm, although the present disclosure is not thereby limited.

In FIG. 3, transducer 12 is scanning a portion of integral seal 20 which includes a bonding defect. It may be noted that outboard edge 76 of rubber sealing member 64 is spaced from edge 78 of seal carrier 62. The gap between these components shown in FIG. 3 may be the result of dis-bonding between rubber sealing member 64 and seal carrier 62 such as might occur as a result of problems in the process of molding rubber sealing member 64 onto seal carrier 62, or resulting from shrinkage of the rubber material of rubber sealing member 64, failure to apply or properly cure adhesive, mechanical decoupling of rubber sealing member 64 from seal carrier 62, or some other problem such as a manufacturing defect in forming edge 78. In any event, a signal trace illustration 200 in FIG. 3 depicts a signal 201 which might be received during scanning the subject portion of integral seal 60. A first signal feature 202 which is received beginning at about a time t₁ appears similar to signal feature 102 shown in FIG. 2. A second signal feature 204 which is received beginning at about a time t₂ is different from signal feature 104 in FIG. 2. In particular, it may be noted that at a time t₂ signal 201 is reduced in amplitude as compared with the signal feature 104. The reduced amplitude may result from scattering of the transmitted ultrasound. Signal 201 may also be inverted in phase as compared to an expected reflection pattern. In particular, the first peak of feature 204 is shown as having a positive sign, in contrast to the first peak of signal feature 104 in FIG. 2. The phase inversion and the reduced amplitude may or may not be perceptible to the human eye, and are somewhat exaggerated for illustrative purposes. Phase inversion, amplitude, time of arrival, and possibly other properties of an ultrasound reflection or features thereof could be electronically detected via an algorithm which recognizes corresponding patterns in raw data or image data, as described herein. In any event, phase inversion may be the result of a dis-bond where air or a vacuum resides between rubber sealing member 64 and seal carrier 62. In other instances, rather than a phase inversion, a dis-bond might be indicated where no signal feature or reflection at all is detected when expected at time t₂. Further, when water has intruded into a gap between rubber sealing member 64 and seal carrier 62, yet another type of signal feature might be seen at approximately time t₂.

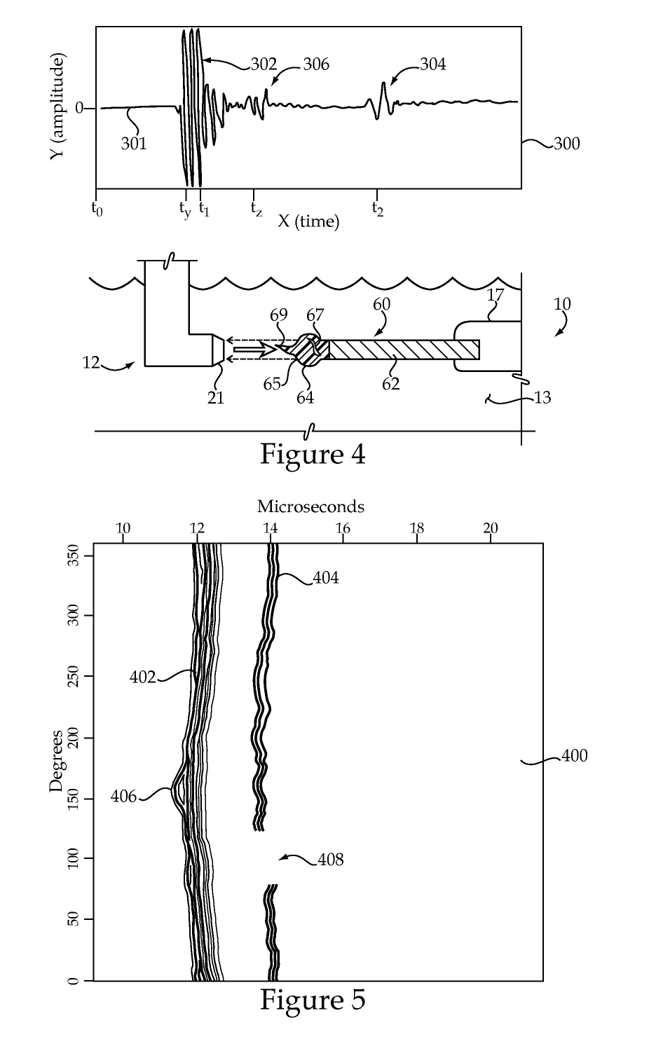

Referring now to FIG. 4, there is shown a portion of system 10 as it might appear where transducer 12 is scanning yet another part of integral seal 60, and still including rubber sealing member 64. In particular, transducer 12 is scanning a part of integral seal 60 where excess flash 69 from the molding procedure which forms rubber sealing member 64 and attaches the same to seal carrier 62 is present, and extends generally in an inboard direction from inboard edge 65. Rubber sealing member 64 also includes an internal defect 67 which may include a crack, void, or inclusion. A signal trace illustration 300 is also shown in FIG. 4 and indicates features of a signal 301 which might be expected when scanning the portion of integral seal 60 shown in FIG. 4. In particular, a first signal feature 302 is shown which is received beginning at approximately a time t_{y}, a second signal feature 304 is shown beginning approximately at a time t₂, and a third signal feature 306 is shown beginning approximately at a time t_{z} prior to time t₂. Time t₁ is shown in FIG. 4, which it may be noted is later than time t_{y}. It may thus be noted that the reflections associated with signal feature 302 may be detected beginning prior to time t₁, as the excess flash 69 may reside relatively closer to transducer 12, at least in the illustrated embodiment. Signal feature 304 may be expected to be similar to signal feature 104 shown in FIG. 2. Signal feature 306 is associated with ultrasound reflections received from internal defect 67, between features 302 and 304 in time. The internal surfaces associated with defect 67 may themselves reflect ultrasound, and thus signal feature 306 would likely not be present where no internal defects are present. Rather than a crack or void, an inclusion of foreign material and the like might result in other unexpected signal features between times t_{y} and t₂.

Referring now to FIG. 5, there is shown a B-scan image 400 such as what might be viewed by an operator on display 36 during inspecting an integral seal according to the present disclosure. In FIG. 5, image 400 shows about 360° of scanning via ultrasonic transducer 12 such as might be obtained by advancing transducer 12 along its entire travel path within one of apertures 61 in integral seal 60. Degrees may be mapped to length dimension of the portion of the integral seal being scanned. Knowledge of the diameter of the rubber sealing member being scanned may be readily used to map degrees to distance, for example, for a circular rubber sealing member. For non-circular shapes, length dimensions might also be mapped based on known geometric relationships for those particular shapes. Image 400 thus might be generated by tracking the inboard edge of a rubber sealing member within an associated aperture of an integral seal until transducer 12 returns to its starting point. Image 400 includes a first reflection 402, which may include one or more reflections from the inboard edge of a rubber sealing member as described herein. A second reflection 404 includes one or more reflections from the rubber-metal interface where the rubber sealing member adjoins the seal carrier. In the illustrated embodiment, reflections 402 and 404 are received about 2 microseconds apart.

One region of reflection 402 is shown at about 150° and is denoted via reference numeral 406. Region 406 appears to bow out relative to the rest of reflection 402, as might be seen where excess flash is present on the surface of the rubber sealing member. The extent of the excess flash may be estimated by the time delay difference between region 406 and the rest of reflection 402, and potentially also based on the angular extent of region 406 which in the example of FIG. 5 spans about 30° to 40°. It will thus be understood that a length and possibly other features such as width of the excess flash may be quantified. In FIG. 4, a length of flash 69 would extend in and out of the page, whereas a width of flash 69 would extend left to right. Time of arrival of the reflection in region 406 could be used to quantify width whereas angular extent of region 406 could be used to quantify length. Since some flashing may be allowed, an operator or computer may compare length and width of flashing, for instance, with a specification. Another region of reflection 404 is denoted via reference numeral 408, and includes a region of reduced amplitude of reflections such that reflection 404 appears to vanish. Such an apparent gap might be seen where transmitted ultrasound scatters at the interface between the rubber sealing member and seal carrier. In some instances, a bonding defect as described herein might result in scattering of the transmitted ultrasound. Such a bonding defect may also be amenable to quantifying based, for instance, on angular extent. Cracks, inclusions, or other defects might be apparent by way of features of image 400 located between reflections 402 and 404, as reflected ultrasound from such features would typically be received after reflection 402 but prior to reflection 404.

It should be appreciated that the mere existence of one or more defects may not always mean that a seal is unsuited for placing in service. The capability to determine or estimate the linear and possibly spatial extents of a defect in an integral seal can allow a tolerance or a threshold to be established for determining whether a defect necessitates scrapping a seal. The present disclosure may thus have applications beyond simply detecting the presence or absence of defects, and can instead enable a computer or a human operator to evaluate whether the number, type and/or size of defects is such that an integral seal needs to be scrapped or whether it has imperfections but is nevertheless suitable for placing in service, or whether it might be repaired. For instance, the excess flash indicated in region 406 might be cut away. Similarly, a technician might attempt to attach a dis-bond indicated in region 408. The integral seal might also be repaired by removing one or more rubber sealing members and re-molding them to the seal carrier.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. While much of the foregoing description focuses on signal features' times of arrival and not properties of the signals themselves, the present disclosure is not thereby limited. Signal gains and ultrasound focusing and frequency, for example, might be varied to enable the further detection and/or characterization of defects based on amplitudes, patterns, phasing and possibly still other properties of raw signal data such as that depicted in FIGS. 2-4. Other aspects, features and advantages will be apparent upon an examination of the attached drawings and appended claims.

What is claimed is:

1. An inspection system for detecting a defect in an integral seal having a rubber sealing member attached to a seal carrier comprising:
an ultrasonic transducer configured to ultrasonically scan an integral seal positioned for inspection via a fixture; and
a transducer positioning mechanism defining a plurality of translational degrees of freedom and a rotational degree of freedom, and being configured to move the ultrasonic transducer relative to the integral seal such that the ultrasonic transducer tracks a contour defined by the rubber sealing member; and
a control system coupled with the ultrasonic transducer and with the transducer positioning mechanism and having a computer readable memory and an electronic control unit;
the electronic control unit being configured to store data on the computer readable memory indicative of a reflection pattern defined by ultrasound reflected by the rubber sealing member and ultrasound reflected by the seal carrier during tracking the contour of the rubber sealing member with the ultrasonic transducer.

2. The inspection system of claim 1 wherein the transducer positioning mechanism is coupled with the ultrasonic transducer and includes at least three co-acting actuators.

3. The inspection system of claim 2 further comprising a housing having an immersion tank for ultrasonic immersion scanning of the integral seal via the ultrasonic transducer.

4. The inspection system of claim 3 wherein the data includes data indicative of an amplitude of ultrasound reflected by the rubber sealing member, and data indicative of an amplitude of ultrasound reflected by the seal carrier.

5. The inspection system of claim 4 wherein the data includes image data.

6. The inspection system of claim 1 wherein the electronic control unit is configured to detect a defect in the integral seal based at least in part on the reflection pattern, and responsively output a signal.

7. The inspection system of claim 6 wherein the electronic control unit is further configured to detect the defect based at least in part on a difference between the reflection pattern and an expected pattern.

8. The system of claim 7 wherein the electronic control unit is configured to detect a defect which includes a bonding defect between the rubber sealing member and the seal carrier.

9. The system of claim 8 wherein the electronic control unit is further configured to detect the bonding defect responsive to a phase inversion in the reflection pattern.

10. The system of claim 6 wherein the electronic control unit is further configured to detect the defect responsive to at least one of, a number of reflections, an amplitude of reflections, and a signal phasing, in the reflection pattern.

11. A method of inspecting an integral seal having a rubber sealing member attached to a seal carrier comprising the steps of:
transmitting ultrasound from an ultrasonic transducer toward the integral seal;
receiving ultrasound reflected by the rubber sealing member, and ultrasound reflected by the seal carrier; and
detecting a defect in the integral seal responsive to a reflection pattern defined by the received ultrasound.

12. The method of claim 11 further comprising a step of moving the ultrasonic transducer relative to the integral seal such that the ultrasonic transducer tracks a contour defined by an inboard edge of the rubber sealing member.

13. The method of claim 12 wherein the step of moving further includes translating the ultrasonic transducer and rotating the ultrasonic transducer, relative to the integral seal.

14. The method of claim 13 wherein the step of transmitting includes transmitting the ultrasound from an inboard side of the rubber sealing member, and such that an ultrasound transmission path is normal to a plane of contact between the rubber sealing member and the seal carrier.

15. The method of claim 13 wherein the seal carrier includes a metallic seal carrier, and the step of receiving includes receiving ultrasound reflected by the metallic seal carrier.

16. The method of claim 15 wherein the step of detecting a defect includes detecting a bonding defect between the rubber sealing member and the metallic seal carrier.

17. The method of claim 15 wherein the step of detecting a defect includes detecting excess flash on the rubber sealing member.

18. The method of claim 11 wherein the step of detecting a defect includes detecting the defect responsive to at least one of, a number of reflections, an amplitude of reflections, and a signal phasing, in the reflection pattern.

19. The method of claim 11 further comprising a step of determining a length or width of the defect responsive to the reflection pattern.

20. A method of detecting a defect in an integral seal:
transmitting ultrasound from an ultrasonic transducer toward an integral seal having a rubber sealing member and a seal carrier attached to the rubber sealing member;
receiving ultrasound reflected by the rubber sealing member, and ultrasound reflected by the seal carrier, the received ultrasound defining a reflection pattern; and
outputting a signal responsive to detecting a defect in the integral seal indicated by the reflection pattern.

21. The method of claim 20 wherein the step of transmitting includes transmitting ultrasound at a plurality of locations along an inboard edge of the rubber sealing member, and wherein the step of receiving includes receiving ultrasound reflected by at least one of the rubber sealing member and the seal carrier at each of the plurality of locations.
